(19) United States
(12) Patent Application Publication
(10) Pub. No.: US 2022/0152812 A1
(43) Pub. Date: May 19, 2022

(54) Exoskeleton for Supporting a User's Arm

(71) Applicant: Yumen Bionics B.V., Amsterdam (NL)

(72) Inventors: Micha Ilan Paalman, Amsterdam (NL); Heero David Egidius Spies, Amsterdam (NL); Sjaak Kok, Amsterdam (NL)

(21) Appl. No.: 17/573,924

(22) Filed: Jan. 12, 2022

Related U.S. Application Data
(63) Continuation of application No. PCT/NL2020/050360, filed on Jun. 4, 2020.

(30) Foreign Application Priority Data
Jul. 15, 2019 (NL) 2023503

(51) Int. Cl. B25J 9/00

(52) U.S. Cl. CPC B25J 9/0006

(57) ABSTRACT

An exoskeleton (1) for supporting a user's arm, comprising a supporting frame (2) that supports an up-and-down movable standard (3, 3′) on which a horizontally movable arm (4, 4′) is mounted. On an extremity of the horizontally movable arm (4, 4′) a back support (5, 5′) is mounted and a supporting arm construction (6, 6′) for supporting the user's arm. The supporting arm construction (6, 6′) is articulated and extendable so as to tailor the arm construction (6, 6′) to the user's arm dimensions. Further, the supporting arm construction (6, 6′) has two limbs (7, 8; 7′, 8′) that connect to each other with a hinge (9, 9′). On opposite sides of the hinge (9. 9′), the limb (8, 8′) that is farthest away from the back support (5, 5′) connects to counterbalancing springs (10, 11; 10′, 11′) that on their opposite sides connect to the upper limb (7, 7′) and directly or indirectly to the horizontally movable arm (4, 4′).

### CROSS-REFERENCE TO RELATED APPLICATIONS

This application is a continuation application of PCT/NL2020/050360, titled “Exoskeleton for Supporting a User's Arm”, filed on Jun. 4, 2020, which claims priority to and the benefit of Netherland Patent Application No. 2023503, titled “Exoskeleton for Supporting a User's Arm”, filed on Jul. 15, 2019, and the specification and claims thereof are incorporated herein by reference.

### BACKGROUND OF THE INVENTION

### Field of the Invention

The invention relates to an exoskeleton for supporting a user's arm, comprising a supporting frame that supports an up-and-down movable standard on which a horizontally movable arm is mounted.

### Background Art

U.S. Pat. No. 8,641,782 discloses such an exoskeleton which compensates for gravity. The known exoskeleton comprises at least five joints, wherein two joints may be driven by actuators, and the remaining joints may be driven by user force.

AT 517255 A1 discloses an arm exoskeleton for the motorized movement of an arm, with several modules and several drives for moving a plurality of joints of the arm.

U.S. Pat. No. 9,358,173 discloses a multi-axis robotic arm having first to eight arm segments, and a high-precision control system for controlling movements of the multi-axis robotic arm. The control system provides an active, a passive and an auxiliary mode; receives and computes information about a patient's movements and muscle force detected by potentiometers and force sensors provided in the multi-axis robotic arm; and accordingly, drives actuators to apply an aiding force or a resisting force to assist the patient in completing rehabilitation exercises.

US2010/0249673 discloses a system for arm therapy comprising a first drive that can be fixedly connected to an element determining the position of a user and rotationally driving, about a first axis, a part of the arm therapy system which can be connected to an upper arm module. The driven part of the arm therapy system comprises a second drive adapted to rotationally drive said upper arm module about a second axis, wherein said second axis is oriented orthogonal to the first axis. The system can provide a statically determined exoskeleton with correct anatomical axes and misaligned technical axes.

WO95/32842 discloses an external apparatus for attachment to a limb of an user and having a selected number of degrees-of-freedom for applying torques to the limb comprising: at least one remote center drive associated with one of the selected number of degrees-of-freedom, wherein the remote center drive is adapted to generate torques on the limb remotely from the center of rotation of the selected degree of freedom.

KR 2018 0123939; CN 107 736 983; and CN 104 021 704 each disclose an exoskeleton for supporting a user's arm, comprising a supporting frame that supports an up-and-down movable standard on which a horizontally movable arm is mounted, wherein the horizontally movable arm carries a back support and a supporting arm construction for supporting the user's arm.

Note that this application refers to a number of publications. Discussion of such publications herein is given for more complete background and is not to be construed as an admission that such publications are prior art for patentability determination purposes.

### BRIEF SUMMARY OF THE INVENTION

It is an object of the invention to provide an exoskeleton which can accurately follow the natural movements of an arm of the user.

It is a further object of the invention to provide an exoskeleton which substantially balances the weight of the arm of the user.

It is still a further object of the invention to provide that the exoskeleton is as much as possible self-supporting without bearing on the body of the user.

The exoskeleton of the invention has the features of one or more of the appended claims.

In a first aspect of the invention the horizontally movable arm is articulated to enable that the exoskeleton can follow all natural movements of the user.

The back support on the horizontally movable arm can in one embodiment be a shoulder plate which accurately positions the supporting arm construction in relation to the user's arm, and which promotes that the supporting arm construction can accurately follow the natural arm movements of the user.

To promote the capability of the exoskeleton to follow the natural movements of the user, it is preferred that the supporting arm construction is articulated and extendable so as to tailor the arm construction to the user's arm dimensions.

Further it is preferred that the supporting arm construction has two limbs that connect to each other with a hinge, and that on opposite sides of the hinge the limb that is farthest away from the back support connects to counterbalancing springs that on their opposite sides connect to the upper limb and directly or indirectly to the horizontally movable arm. The counterbalancing springs are important for reducing the weight of the user's own arm that has to be compensated by the user himself.

Preferably the limb that is farthest away from the at least one back support supports a flexible arm sleeve. With such a flexible arm sleeve a play free connection with an user's arm can be secured.

It is further preferred that the limb that is farthest away from the at least one back support is provided with an attached gripping flap. Such a gripping flap is very helpful when support of the user's arm is required.

Advantageously the limb that is farthest away from the back support is provided with a brace that extends above the flexible arm sleeve. The brace secures the dimensional fit of the flexible arm sleeve, and in particular the construction of the lower limb of the arm construction.

The up-and-down movability of the standard can be realized in different ways. In one embodiment the up-and-down movable standard is supported through a parallelogram mechanism by the supporting frame.

It is then preferred that the parallelogram mechanism has guide wheels that guide a tension wire so as to provide a weight compensating upward force to the parallelogram mechanism.

Suitably the tension wire has two extremities, and connects on a first extremity of the two extremities to a spring mounted on the frame.

It is preferable that on a second extremity of the two extremities the tension wire connects to an adjustment knob, which makes adaptation to the requirements of a particular situation easy.

In another embodiment which may have preference because of the size reduction that is possible, the up-and-down movable standard is guided in a linear bearing mounted in the supporting frame.

Also then the up-and-down movable standard is preferably connected with a tension wire that connects to a spring mounted on the up-and-down movable standard.

In one embodiment the tension wire is guided over at least one guide wheel, wherein said at least one guide wheel is mounted on a swivel arm which has a hinge that connects to the up-and-down movable standard and which swivel arm connects with a link to the supporting frame at a position distant from the hinge so as to fix said position in vertical direction with reference to the supporting frame.

In this embodiment it is preferred that at a position distant from the spring, the tension wire is connected to an adjustment mechanism for adjusting a tension in the tension wire.

In still another embodiment the tension wire is guided over at least one guide wheel, wherein said at least one guide wheel is mounted on the standard, which standard connects to a swivel and slide arm which has a hinge distant from the standard that connects to the supporting frame so as to fix said hinge with reference to the supporting frame.

Suitably the supporting arm construction for the users arm is mounted on the horizontally movable arm through an intermediate shoulder hinge and adapter, which shoulder hinge and adapter comprises two articulate bended linkages that interconnect with a central hinge, and wherein said bended linkages on their respective sides distant from the central hinge are each provided with a further hinge that provides a swivable connection with the horizontally movable arm and the supporting arm construction, respectively. This further promotes the adaptation of the exoskeleton to the natural posture that a user can assume.

Preferably the said hinges are lockable, to enable easy mounting or dismounting of the exoskeleton to a user.

In particular situations where a user needs his two arms to be supported by an exoskeleton, it is desirable that the exoskeleton is provided with two standards, horizontal movable arms, and supporting arm constructions that are provided on the supporting frame in mirror image, and at least one back support so as to provide that the exoskeleton can indeed support two arms of the user.

Preferably then the two horizontal arms that support the at least one back support are connected to each other with a back connector. This secures the stability of the exoskeleton and adaptation to the user during use.

Preferably the back connector has an adjustable length to be able to tailor the exoskeleton to the user.

A further preferable feature is that the spring that connects the limb that is farthest away from the at least one back support, to the horizontally movable arm has an Y-shape wherein the branches of the Y connect to the limb, and the other side of the Y connects to the horizontally movable arm. This promotes stability and reduces the risk that breakage of the spring will lead to a collapsing exoskeleton.

Finally it is remarked that the exoskeleton only comprises passive components, which is a competitive advantage over prior art solutions.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1, 2A, 2B and 3 show an exoskeleton according to an embodiment of the present invention in a frontal view, isometric view and side view, respectively;

FIGS. 4, 5 and 6 show back sides of three different embodiments of the exoskeleton of the present invention;

FIGS. 7 and 8 show a detailed view of one embodiment of the exoskeleton of the invention;

FIGS. 9 and 10 show a detailed view of a second embodiment of the exoskeleton of the present invention;

FIGS. 11 and 12 show a detailed view of a third embodiment of the exoskeleton of the present invention;

FIG. 13 shows a detailed view at a shoulder construction of the exoskeleton according to an embodiment of the present invention; and

FIG. 14 shows one of the springs that is used in an exoskeleton according to an embodiment of the present invention.

### DETAILED DESCRIPTION OF THE INVENTION

Whenever in the figures the same reference numerals are applied, these numerals refer to the same parts.

In the figures and the following discussion an exoskeleton according to an embodiment of the present invention will be shown as comprising two standards, two horizontal movable arms, one or two back supports, and two supporting arm constructions that are provided on the supporting frame in mirror image, so as to provide that the exoskeleton can support two arms of a user. The skilled person will understand that for that purpose also other features that relate to supporting two arms of a user will be present in twofold, as the situation may require. It is however also feasible that the exoskeleton only provides a single standard, a single horizontally movable arm, a single back support, and a single supporting arm construction to provide support to only one user's arm. To avoid any doubt, it is remarked that it is not feasible that the exoskeleton will be embodied with three standards etc. It is further remarked that the exoskeleton of the invention only comprises passive components and preferably avoids all motorization. It is found that the exoskeleton of the invention is particularly suitable for use by male persons suffering from Duchenne muscular dystrophy (nature discriminates between the sexes). According to Wikipedia Duchenne muscular dystrophy is a severe type of muscular dystrophy. The symptom of muscle weakness usually begins around the age of four in boys and worsens quickly. Typically, muscle loss occurs first in the thighs and pelvis followed by those of the arms. This can result in trouble standing up. Most are unable to walk by the age of 12.

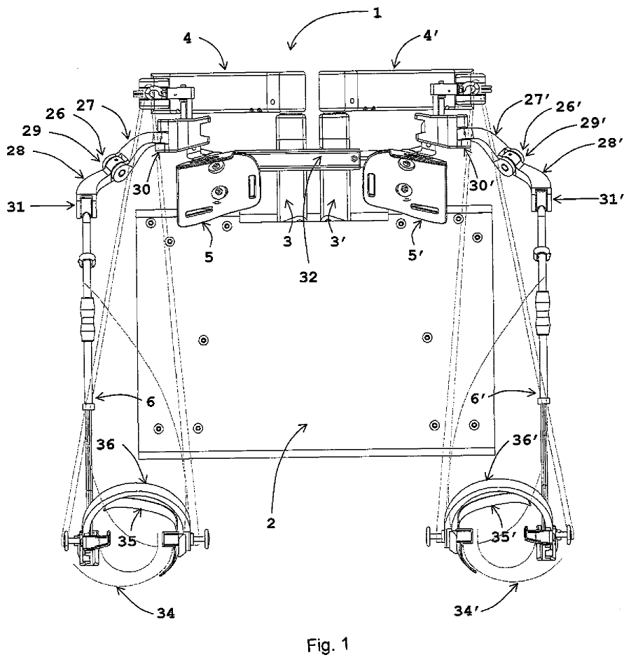

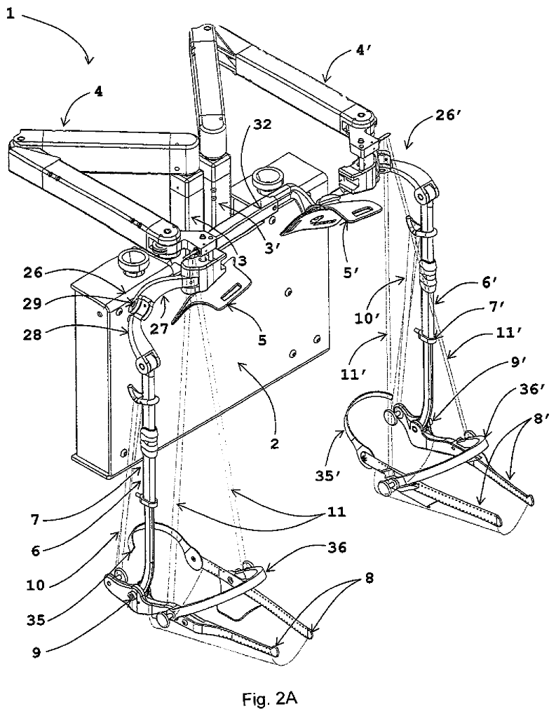

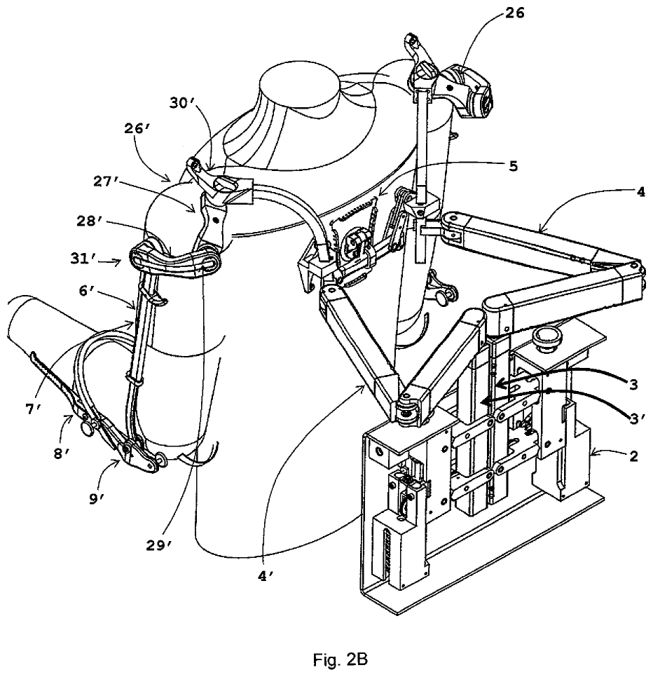

With reference first to FIGS. 1, 2A, 2B and 3 an exoskeleton 1 of the invention is shown in a frontal view, an isometric frontal view, an isometric back view, and a side view, respectively. The difference between FIG. 2A and FIG. 2B is that the embodiment of FIG. 2A has two back supports 5, whereas the embodiment of FIG. 2B only has a single back support 5. The exoskeleton 1 is used for supporting at least one arm of a user, and comprises a supporting frame 2 that supports an up-and-down movable standard 3, 3′ on which a horizontally movable arm 4, 4′ is mounted.

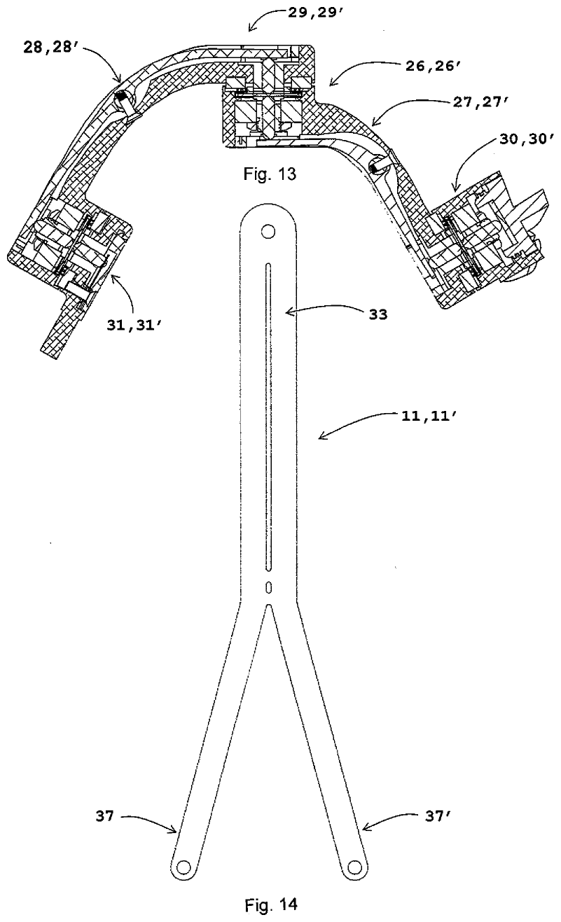

On the horizontally movable arm 4, 4′ at least one back support 5, 5′ is (indirectly) mounted as well as a supporting arm construction 6, 6′ for supporting the user's arm. The supporting arm construction 6, 6′ for the user's arm is mounted on the horizontally movable arm 3, 3′ through an intermediate shoulder hinge and adapter 26, 26′ which is in detail shown in FIG. 13. FIG. 13 shows that the shoulder hinge and adapter 26, 26′ comprises two articulate bended linkages 27, 28; 27′, 28′ that interconnect with a central hinge 29, 29′ and wherein said bended linkages 27, 28; 27′, 28′ on their respective sides distant from the central hinge 29, 29′ are each provided with a further hinge 30, 31; 30′, 31′ that provides a swivable connection with the horizontally movable arm 4, 4′ and the supporting arm construction 6, 6′ for the user's arm, respectively. The hinges are all lockable to assist during donning and doffing of the exoskeleton.

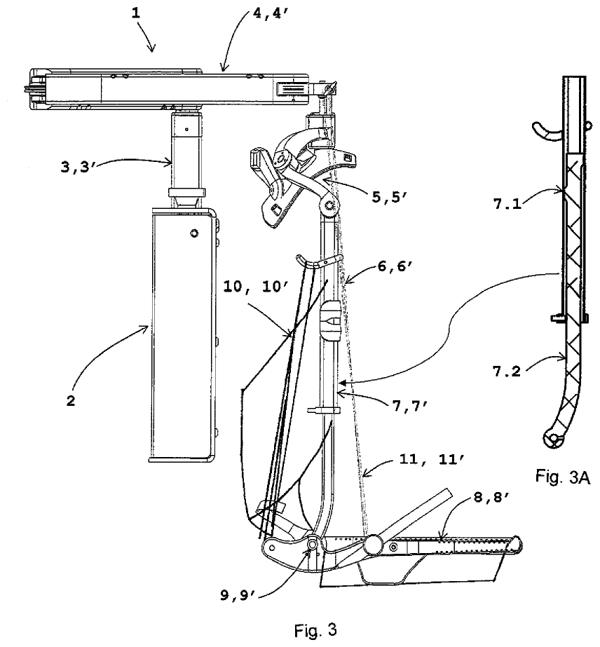

Turning back to FIGS. 1-3, it is shown that the supporting arm construction 6, 6′ is articulated and extendable so as to tailor the arm construction 6, 6′ to the user's arm dimensions. For this purpose an upper limb 7, 7′ of the supporting arm construction 6, 6′ comprises two telescopically extendable tubes 7.1, 7.2 as clearly shown in FIG. 3a.

As is best shown in FIGS. 2A, 2B and 3, the supporting arm construction 6, 6′ has an upper limb 7, 7′ and a lower limb 8, 8′ that connect to each other with a hinge 9, 9′. FIGS. 2A and 3 show that on opposite sides of the hinge 9, 9′ the lower limb 8, 8′ that is farthest away from the at least one back support 5, 5′ connects to counterbalancing springs 10, 11; 10′, 11′ that on their opposite sides connect to the upper limb 7, 7′ and directly or indirectly to the horizontally movable arm 4, 4′, respectively. FIG. 14 shows the spring 11, 11′ that connects the lower limb 8, 8′ that is farthest away from the at least one back support 5, 5′ to the horizontally movable arm 4, 4′. It shows that the spring 11, 11′ has a Y-shape wherein the branches 37, 37′ of the Y connect to the lower limb 8, 8′ and the other side 33 of the Y connects to the horizontally movable arm 4, 4′.

FIG. 1 and FIGS. 2A and 2B show that the limb 8, 8′ that is farthest away from the at least one back support 5, 5′ supports a flexible arm sleeve 34, 34′. This limb 8, 8′ is further provided with an attached gripping flap 35, 35′, and further with a brace 36, 36′ that extends above the flexible arm sleeve 34, 34′.

FIGS. 2A and 2B provide a best view to show that the horizontally movable arm 4, 4′ is articulated.

FIG. 1 and FIGS. 2A and 2B further show that the two horizontal arms 4, 4′ that support the at least one back support 5, 5′ are connected to each other with a back connector 32, which preferably has an adjustable length.

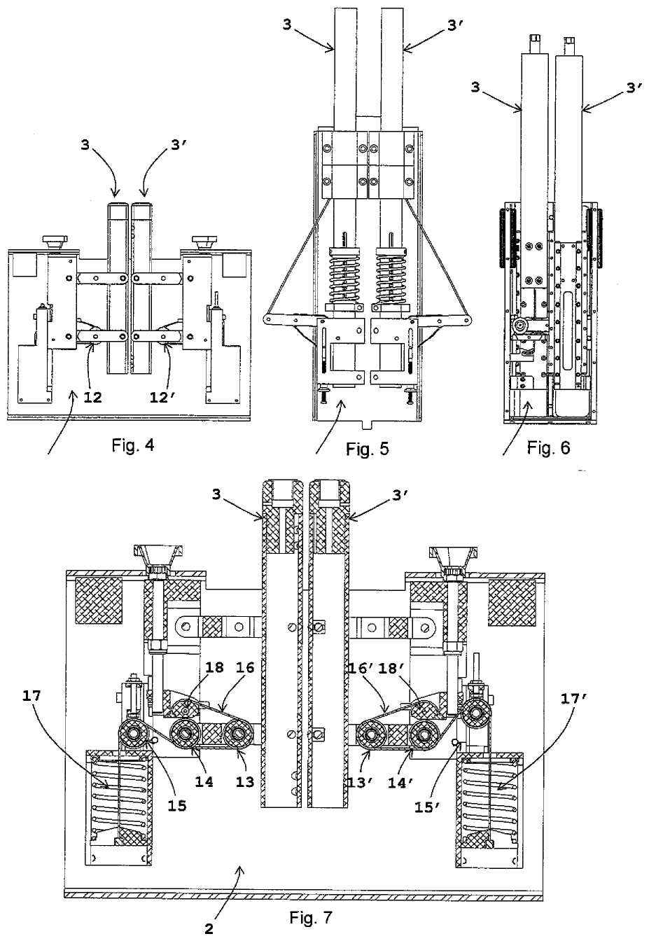

Turning now to a first embodiment of a construction by which the standard 3, 3′ is supported by the frame 2, reference is made to FIGS. 4, 7, and 8, wherein it is shown that the up-and-down movable standard 3, 3′ is supported through a parallelogram mechanism 12, 12′ by the supporting frame 2.

In FIG. 7 it is shown that the parallelogram mechanism 12, 12′ has guide wheels 13, 14 and 15, 13′, 14′ and 15′ that guide a tension wire 16, 16′ so as to provide an upward force to the parallelogram mechanism 12, 12′. The tension wire 16, 16′ has two extremities, and connects on a first extremity of the two extremities to a spring 17, 17′ mounted on the frame 2. On a second extremity of the two extremities the tension wire 16, 16′ connects to an adjustment knob 18, 18′ for adjusting the tension in the wire 16, 16′.

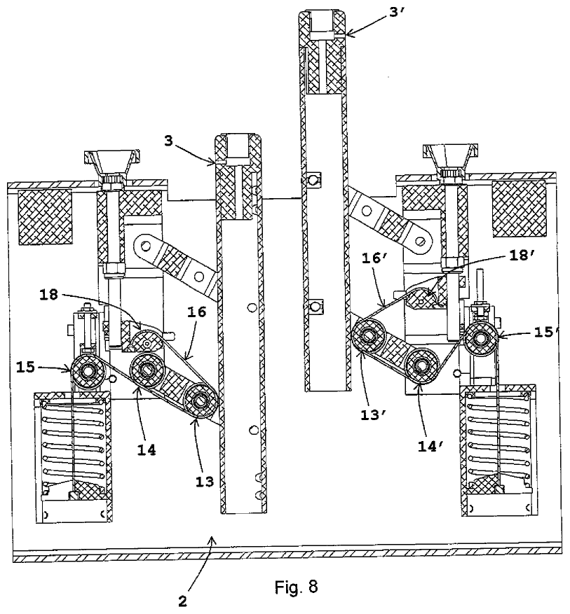

FIG. 8 shows the up-and-down movability of the standards 3, 3′ as supported according to the first embodiment, wherein on the left the standard 3 is moved to a lowermost position, and on the right the standard 3′ is moved to a highest position.

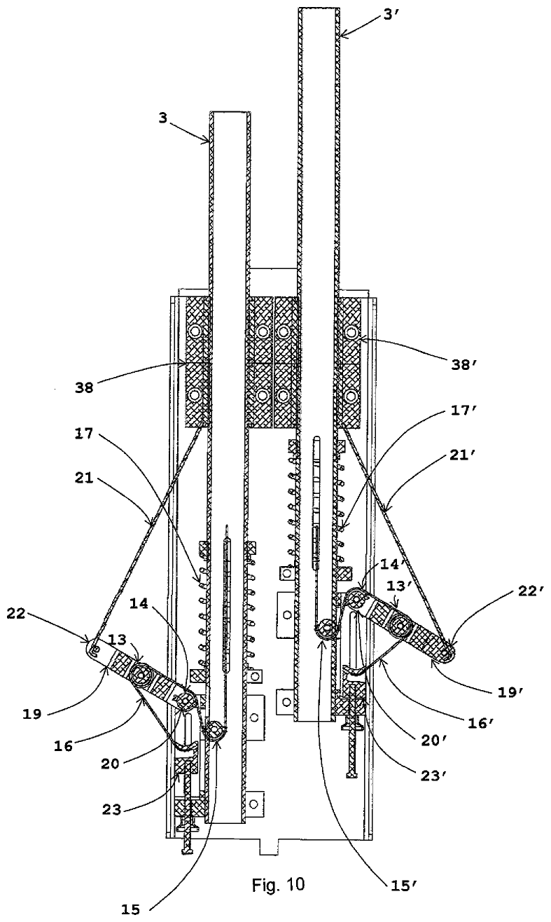

With reference to FIGS. 5, 9 and 10, a second embodiment is shown pertaining to a construction wherein the standard 3, 3′ is supported by the frame 2. In this second embodiment the up-and-down movable standard 3, 3′ is guided in a linear bearing 38, 38′ mounted in the supporting frame 2. Here the up-and-down movable standard 3, 3′ is balanced with a tension wire 16, 16′ that connects to a spring 17, 17′ mounted on the up-and-down movable standard 3, 3′. The tension wire 16, 16′ is guided over at least one guide wheel 13, 13′, wherein said at least one guide wheel 13, 13′ is mounted on a swivel arm 19, 19′ which has a hinge 20, 20′ that connects to the up-and-down movable standard 3, 3′, and which swivel arm 19, 19′ connects further with a rigid link 21, 21′ to the supporting frame 2 at a position 22, 22′ distant from the hinge 20, 20′ so as to fix said position 22, 22′ with reference to the supporting frame 2. This is visually illustrated in FIG. 10 wherein the left standard 3 is moved to a lowermost position, and the right standard 3′ is moved to a highest position, and wherein the positions 22, 22′ at which the connections are made between the links 21, 21′ and the swivel arms 19, 19′ are maintained at essentially the same altitude with reference to the frame 2.

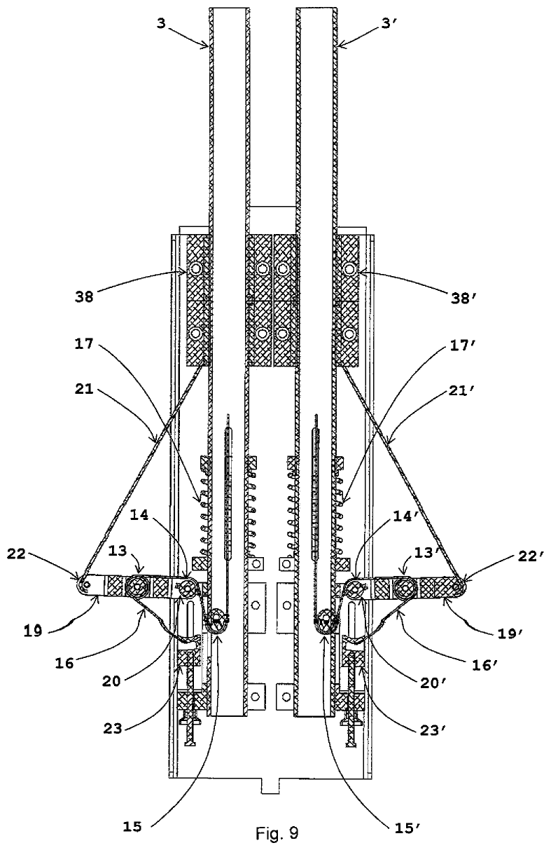

FIGS. 9 and 10 also show that at a position distant from the spring 17, 17′ the tension wire 16, 16′ is connected to an adjustment mechanism 23, 23′ for adjusting a tension in the tension wire 16, 16′.

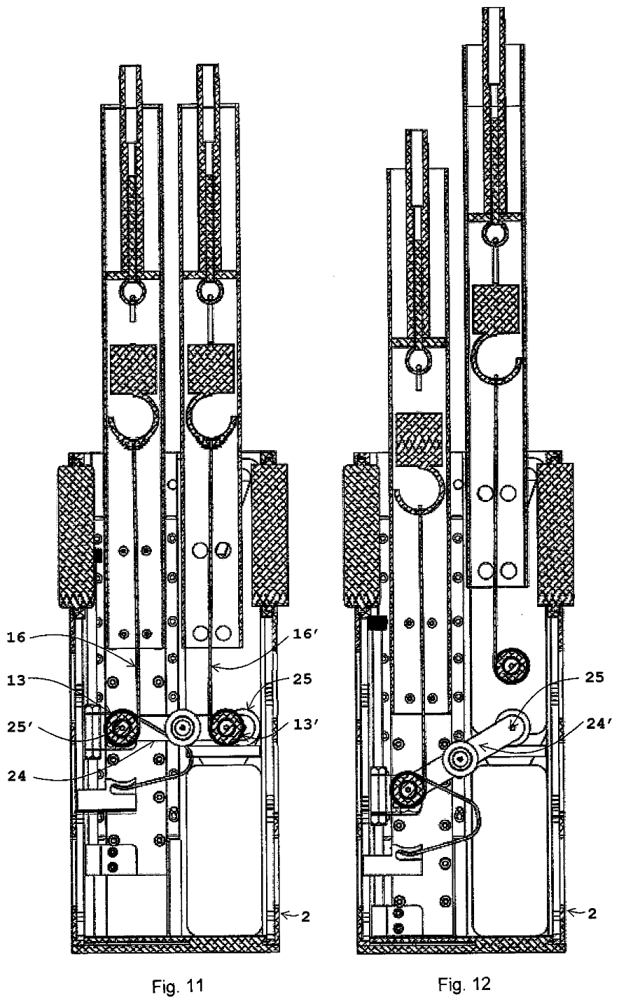

A third embodiment is shown with reference to FIGS. 6, 11 and 12. In this third embodiment the tension wire 16, 16′ is guided over at least one guide wheel 13, 13′, wherein said at least one guide wheel 13, 13′ is mounted on the standard 3, 3′, wherein said standard 3, 3′ connects to a swivel and slide arm 24, 24′ which has a hinge 25, 25′ distant from the standard 3, 3′ that connects to the supporting frame 2 so as to fix said hinge 25, 25′ in altitude with reference to the supporting frame 2.

Although the invention has been discussed in the foregoing with reference to exemplary embodiments of the exoskeleton of the invention, the invention is not restricted to these particular embodiments which can be varied in many ways without departing from the invention. The discussed exemplary embodiments shall therefore not be used to construe the appended claims strictly in accordance therewith. On the contrary the embodiments are merely intended to explain the wording of the appended claims without intent to limit the claims to these exemplary embodiments. The scope of protection of the invention shall therefore be construed in accordance with the appended claims only, wherein a possible ambiguity in the wording of the claims shall be resolved using these exemplary embodiments.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1. An exoskeleton for supporting a user's arm, the exoskeleton comprising:
a supporting frame that supports an up-and-down movable standard on which a horizontally movable arm is mounted, wherein the horizontally movable arm carries a back support and a supporting arm construction for supporting the user's arm, and wherein the horizontally movable arm is articulated.

2. The exoskeleton according to claim 1, wherein the supporting arm construction is articulated and extendable so as to tailor the arm construction to the user's arm dimensions.

3. The exoskeleton according to claim 1, wherein the supporting arm construction comprises two limbs that connect to each other with a hinge, and that on opposite sides of the hinge the limb that is farthest away from the back support connects to counterbalancing springs that on their opposite sides connect to the upper limb and directly or indirectly to the horizontally movable arm.

4. The exoskeleton according to claim 3, wherein the limb that is farthest away from the back support supports a flexible arm sleeve.

5. The exoskeleton according to claim 3, wherein the limb that is farthest away from the back support comprises an attached gripping flap.

6. The exoskeleton according to claim 3, wherein the limb that is farthest away from the back support comprises a brace that extends above the flexible arm sleeve.

7. The exoskeleton according to claim 1, wherein the up-and-down movable standard is supported through a parallelogram mechanism by the supporting frame.

8. The exoskeleton according to claim 7, wherein the parallelogram mechanism comprises a guide wheel or guide wheels that guide a tension wire so as to provide an upward force to the parallelogram mechanism.

9. The exoskeleton according to claim 8, wherein the tension wire comprises two extremities, and connects on a first extremity of the two extremities to a spring mounted on the supporting frame.

10. The exoskeleton according to claim 9, wherein on a second extremity of the two extremities the tension wire connects to an adjustment knob.

11. The exoskeleton according to claim 1, wherein the up-and-down movable standard is guided in a linear bearing mounted to the supporting frame.

12. The exoskeleton according to claim 11, wherein the up-and-down movable standard is connected with a tension wire that connects to a spring mounted on the up-and-down movable standard.

13. The exoskeleton according to claim 12, wherein the tension wire is guided over at least one guide wheel, wherein said at least one guide wheel is mounted on a swivel arm which has a hinge that connects to the up-and-down movable standard and which swivel arm connects with a link to the supporting frame at a position distant from the hinge so as to essentially fix said position in vertical direction with reference to the supporting frame.

14. The exoskeleton according to claim 13, wherein at a position distant from the spring the tension wire is connected to an adjustment mechanism for adjusting a tension in the tension wire.

15. The exoskeleton according to claim 12, wherein the tension wire is guided over at least one guide wheel, wherein said at least one guide wheel is mounted on the standard, which standard connects to a swivel and slide arm which comprises a hinge distant from the standard that connects to the supporting frame so as to fix said hinge with reference to the supporting frame.

16. The exoskeleton according to claim 1, wherein the supporting arm construction for the user's arm is mounted on the horizontally movable arm through an intermediate shoulder hinge and adapter, which shoulder hinge and adapter comprises two articulate bended linkages that interconnect with a central hinge, and wherein said bended linkages on their respective sides distant from the central hinge are each provided with a further hinge that provides a swivable connection with the horizontally movable arm and the supporting arm construction, respectively.

17. The exoskeleton according to claim 16, wherein the hinges are lockable.

18. The exoskeleton according to claim 1, wherein the exoskeleton is provided with two standards, horizontal movable arms, and supporting arm constructions that are provided on the supporting frame in mirror image, and at least one back support so as to provide that the exoskeleton can support two arms of the user.

19. The exoskeleton according to claim 18, wherein the two horizontal arms support the at least one back support, and are connected to each other with a back connector.

20. The exoskeleton according to claim 19, wherein the back connector has an adjustable length.

21. The exoskeleton according to claim 3, wherein the spring that connects the limb that is farthest away from the back support to the horizontally movable arm comprises a Y-shape wherein the branches of the Y connect to the limb and the other side of the Y connects to the horizontally movable arm.

22. The exoskeleton according to claim 1, wherein the exoskeleton only comprises passive components.
